(19) United States
(12) Patent Application Publication
(10) Pub. No.: US 2026/0259765 A1
(43) Pub. Date: Sep. 3, 2026

(54) INFORMATION PROCESSING APPARATUS, ELECTRONIC DATA PROVISION APPARATUS, AND NON-TRANSITORY RECORDING MEDIUM

(71) Applicant: PFU Limited, ISHIKAWA (JP)

(72) Inventor: Akira IWAYAMA, ISHIKAWA (JP)

(21) Appl. No.: 19/542,025

(22) Filed: Feb. 17, 2026

(30) Foreign Application Priority Data
Mar. 3, 2025 (JP) 2025-033112

(51) Int. Cl. G06F 9/48

(52) U.S. Cl. CPC G06F 9/485

(57) ABSTRACT

An information processing apparatus includes circuitry to obtain first electronic data for executing a task including a plurality of operations, perform a training using operation information to generate second electronic data. The operation information indicates one or more user operations performed in executing the task based on the first electronic data. The circuitry executes the task based on the second electronic data.

### CROSS-REFERENCE TO RELATED APPLICATIONS

This patent application is based on and claims priority pursuant to 35 U.S.C. §119(a) to Japanese Patent Application No. 2025-033112, filed on March 3, 2025, in the Japan Patent Office, the entire disclosure of which is hereby incorporated by reference herein.

### BACKGROUND

The present disclosure relates to an information processing apparatus, an electronic data provision apparatus, and a non-transitory recording medium.

There is a technique for automating tasks using an information processing apparatus. For example, a computing device determines a process and a state transition of a captured step of an application workflow, identifies an action based on a sequencing model associated with the captured step and a change in a log file of the action, and generates a hierarchy for automatically creating an automated workflow for robotic process automation based on the identified action.

### SUMMARY

The information processing apparatus according to one aspect of the present disclosure includes circuitry to obtain first electronic data for executing a task including a plurality of operations, perform training using operation information to generate second electronic data. The operation information indicates one or more user operations performed in executing the task based on the first electronic data. The circuitry executes the task based on the second electronic data.

The electronic data provision apparatus according to another aspect of the present disclosure includes a memory and circuitry. The memory stores first electronic data for executing a task including a plurality of operations. The circuitry receives a request for acquisition of the first electronic data from an information processing apparatus communicably connected to the data provision apparatus and transmits the first electronic data to the information processing apparatus.

The electronic data provision apparatus according to still another aspect of the present disclosure includes a memory and circuitry. The memory stores first electronic data for executing at least one task including a plurality of operations. The circuitry receives, from an information processing apparatus communicably connected to the electronic data provision apparatus, operation information indicating a user operation performed in executing the task, and performs training using the operation information to update the first electronic data.

The non-transitory recording medium according to still another aspect of the present disclosure stores a plurality of instructions which, when executed by one or more processors, causes the one or more processors to perform a method. The method includes obtaining first electronic data for executing a task including a plurality of operations, and performing training using operation information indicating a user operation performed in executing the task based on the first electronic data to generate second electronic data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an automation system according to a first embodiment;

FIG. 2 is another diagram illustrating an overall configuration of an automation system according to the first embodiment;

FIG. 3 is a block diagram illustrating a hardware configuration of a computer;

FIG. 4 is a block diagram illustrating a functional configuration of an edge device;

FIGS. 5A to 5C (FIG. 5) are a diagram illustrating information stored in an edge device;

FIG. 6 is a flowchart of a generation process;

FIG. 7 is a flowchart of an additional training process;

FIG. 8 is a flowchart of an execution process;

FIG. 9 is a diagram illustrating an overall configuration of an automation system according to a second embodiment;

FIG. 10 is another diagram illustrating an overall configuration of an automation system according to the second embodiment;

FIG. 11 is a block diagram illustrating a functional configuration of a management server;

FIG. 12 is a diagram illustrating model usage management information;

FIG. 13 is a diagram illustrating data provision management information; and

FIG. 14 is a flowchart of a management method.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In this specification and drawings, components having substantially the same functional configurations are denoted by like reference signs, and redundant descriptions thereof are simplified or omitted.

### First Embodiment

In a first embodiment of the present disclosure, an example of an automation system that automates one or more tasks. In this disclosure, one or more tasks include multiple operations performed on an information processing apparatus.

For example, tasks may be performed in corporate environments as part of business processes, or in personal settings such as at home. Examples of tasks include planning travel, purchasing items, placing takeout orders, applying for business trips and leave, coordinating meetings, arranging transportation, ordering products, routing food deliveries, comparing products, preparing meeting minutes, handling reception, reviewing legal documents, executing audits, managing contracts, issuing certificates, controlling exports, transferring personnel, reviewing documents, and conducting reputation searches. In the following description of some embodiments, an automation system that automates a business process performed in, for example, a company is described.

### Overall Configuration

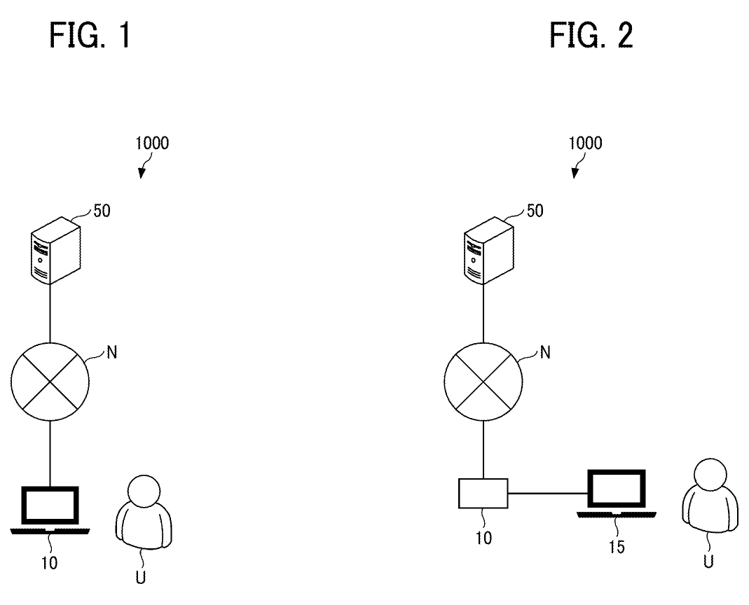

FIG. 1 is a diagram illustrating an overall configuration of an automation system according to the first embodiment. As illustrated in FIG. 1, an automation system 1000 includes an edge device 10 and a business system 50. The edge device 10 and the business system 50 are connected to each other via a communication network N for data communication. The communication network N may be, for example, a local area network (LAN), a virtual private network (VPN), or the Internet.

The edge device 10 is an example of an information processing apparatus that executes a business process including one or more tasks. For example, the edge device 10 may be a computer such as a personal computer, a tablet terminal, or a smartphone. The edge device 10 illustrated in FIG. 1 is operated by a user U. The edge device 10 executes a business process based on operations performed by the user U.

Examples of operations performed by the user U include screen operations, text input, voice input, and image input. For example, an operation may be performed by the user U through an input device such as a keyboard, mouse, touch panel, touchpad, microphone, camera, or sensor. Examples of sensors used as input devices include a positioning sensor, a gyro sensor, a trigger sensor, an acceleration sensor, a log sensor, a temperature sensor, and a vibration sensor.

The business system 50 is an example of an information processing system that executes processing related to business processes. For example, the business system 50 may be implemented by a computer such as a personal computer, a workstation, or a server. The business system 50 may include one or more computers. The business system 50 may also be a cloud computing service.

FIG. 2 is another diagram illustrating an overall configuration of an automation system according to the first embodiment. As illustrated in FIG. 2, the automation system 1000 may further includes an operator terminal 15 in addition to the edge device 10 and the business system 50. The edge device 10 and the operator terminal 15 are connected to each other for data communication via a communication network N or a serial communication using a universal serial bus (USB) cable. The edge device 10 may be built in the operator terminal 15.

The edge device 10 and the operator terminal 15 may be connected to each other for data communication via the bus line of the operator terminal 15.

The edge device 10 illustrated in FIG. 2 may be an information processing apparatus without a user interface. For example, the edge device 10 may be an embedded device such as a set-top box. The edge device 10 receives operation information from the operator terminal 15. The edge device 10 executes a business process based on the operation information received from the operator terminal 15.

The operator terminal 15 is an example of an information processing apparatus operated by the user U. For example, the operator terminal 15 may be a computer such as a personal computer, a tablet terminal, or a smartphone. The operator terminal 15 transmits operation information on an operation performed by the user U to the edge device 10. Integration software to collect operation information and transmit the operation information to the edge device 10 may be installed on the operator terminal 15.

As illustrated in FIG. 1, when the edge device 10 is directly operable by the user U, the system configuration is simpler and easier to implement than the configuration as illustrated in FIG. 2. On the other hand, as illustrated in FIG. 2, when the edge device 10 that executes a business process and the operator terminal 15 operated by the user U are separated, the business process can be automated without depending on the specifications of the operator terminal 15. Further, by separating the edge device 10 and the operator terminal 15, a business process using personal information can be performed in a closed environment, thereby enhancing security.

The overall configuration of the automation system 1000 illustrated in FIG. 1 or FIG. 2 is one example, and the system configuration may vary depending on the application or purpose. For example, the automation system 1000 may include two or more edge devices 10 or two or more business systems 50. For example, the business system 50 may be implemented by multiple computers or may be implemented as a cloud computing service. The classification of apparatuses or systems such as the edge device 10, the operator terminal 15, and the business system 50 illustrated in FIG. 1 or FIG. 2 is an example.

### Hardware Configuration

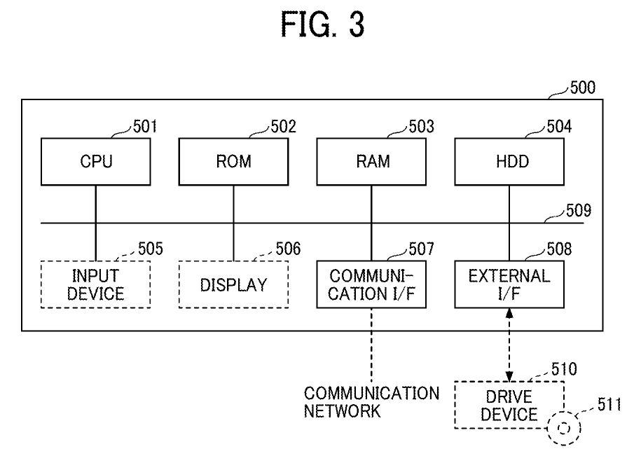

The hardware configuration of the automation system 1000 is described below with reference to FIG. 3. Each of the edge device 10, the operator terminal 15, and the business system 50 may be implemented by, for example, a computer. FIG. 3 is a block diagram illustrating a hardware configuration of a computer.

As illustrated in FIG. 3, a computer 500 includes a central processing unit (CPU) 501, a read-only memory (ROM) 502, a random-access memory (RAM) 503, a hard disk drive (HDD) 504, an input device 505, a display 506, a communication interface (I/F) 507, and an external I/F 508. The CPU 501, the ROM 502, and the RAM 503 form a so-called computer. The hardware components of the computer 500 are connected to each other via a bus line 509. The input device 505 and the display 506 may be connected via the external I/F 508 rather than directly to the bus line 509, and this may also be used as a form of use.

The CPU 501 reads programs or data from a memory such as the ROM 502 or the HDD 504 into the RAM 503 and executes processing for controlling the computer 500 or implementing a function of the computer 500. The computer 500 may include a graphics processing unit (GPU) in addition to the CPU 501 or instead of the CPU 501.

The ROM 502 is an example of a nonvolatile semiconductor memory (storage device) that retains programs or data even after the power is turned off. The ROM 502 functions as a main memory that stores various programs and data used by the CPU 501 to execute various programs installed on the HDD 504. Specifically, the ROM 502 stores boot programs such as a basic input output system (BIOS) and an external executable firmware interface (EFI) executed at the time of booting the computer 500, and data such as operating system (OS) settings and network settings.

The RAM 503 is an example of a volatile semiconductor memory (storage device) from which programs or data are erased when the power is turned off. The RAM 503 is, for example, a dynamic random-access memory (DRAM) or a static random-access memory (SRAM). The RAM 503 provides a work area for loading various programs installed on the HDD 504 when the programs are executed by the CPU 501.

The HDD 504 is an example of a nonvolatile memory that stores programs or data. The programs or data stored in the HDD 504 include an OS that is basic software for controlling the computer 500 and applications that provide various functions on the OS. The computer 500 may use a memory (for example, a solid-state drive (SSD)) using a flash memory as a storage medium instead of the HDD 504.

The input device 505 is used by a user to input various signals. The input device 505 includes a touch panel, operation keys or buttons, a keyboard, a mouse, and a microphone for inputting sound data such as voice.

The display 506 includes at least a display such as a liquid crystal display or an organic electro-luminescence (EL) display that displays a screen, and a speaker that outputs sound data such as voice.

The communication I/F 507 is an interface for connecting to a communication network that allows the computer 500 to perform data communication.

The external I/F 508 is an interface that connects the computer 500 to an external device. The external device includes a drive device 510.

The drive device 510 is a device for setting a recording medium 511. Examples of the recording medium 511 include a compact disc-read-only memory (CD-ROM), a flexible disk, and a magneto-optical disc that records data optically, electrically or magnetically. Other examples of the recording medium 511 include a semiconductor memory such as a ROM or a flash memory that electrically records data. The external I/F 508 allows the computer 500 to read or write data from or to the recording medium 511.

For example, the various programs are installed on the HDD 504 by placing the distributed recording medium 511 into the drive device 510 connected to the external I/F 508 and reading the various programs recorded on the recording medium 511 by the drive device 510. Alternatively, the various programs may be installed in the HDD 504 may be installed by being downloaded from another network different from the communication network N via the communication I/F 507.

### Functional Configuration

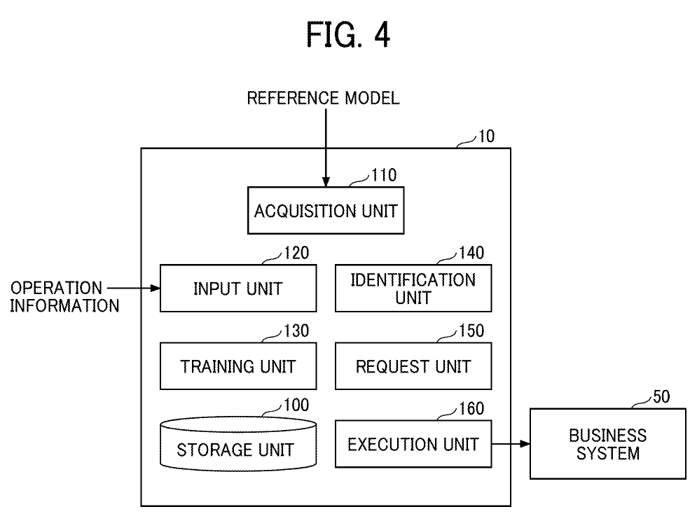

A functional configuration of the automation system 1000 is described below with reference to FIG. 4. FIG. 4 is a block diagram illustrating a functional configuration of an edge device.

As illustrated in FIG. 4, the edge device 10 includes a storage unit 100, an acquisition unit 110, an input unit 120, a training unit 130, an identification unit 140, a request unit 150, and an execution unit 160. The storage unit 100, the acquisition unit 110, the input unit 120, the training unit 130, the identification unit 140, the request unit 150, and the execution unit 160 are implemented by executing one or more programs pre-installed on the edge device 10.

Multiple programs may be installed on the edge device 10 to implement the processing units illustrated in FIG. 4. For example, a first program to implement the acquisition unit 110, the input unit 120, the training unit 130, the identification unit 140, and the request unit 150 and a second program to implement the execution unit 160 may be installed on the edge device 10.

For example, the storage unit 100 is implemented by the HDD 504 illustrated in FIG. 3. For example, the acquisition unit 110, the input unit 120, the training unit 130, the identification unit 140, the request unit 150, and the execution unit 160 are implemented by processing that is executed by the CPU 501 according to a program that is loaded from the HDD 504 illustrated in FIG. 3 into the RAM 503.

The storage unit 100 stores a reference model and a business process model. The reference model is an example of first electronic data for executing one or more tasks including multiple operations. The reference model is a model pre-trained on basic operations related to a business process. The reference model may be created manually by an administrator. Alternatively, the reference model may be generated based on generative models such as large language models (LLM) or may be generated based on operation information obtained when the user U manually performs a business process, in a rule-based manner. The storage unit 100 may store multiple reference models according to the type of business process.

The business process model is an example of a second electronic data and has learned operation information related to one or more operations performed in executing a business process based on the reference model. The business process model is a model trained additionally on specific operations related to a business process. The business process model is generated by the training unit 130.

The reference model and the business process model may be stored in a database The reference model and the business process model may be electronic data generated by a robotic process automation (RPA) tool. For example, the reference model and the business process model may include a definition file that causes the RPA tool to execute a scenario or a workflow, or may include an agent program that executes the RPA scenario or the workflow.

The storage unit 100 further stores account information. The account information is information about the account of the user U for connecting to the business system 50. For example, the account information may include connection destination information of the business system 50, identification information of the user U, and a predetermined password. The connection destination information of the business system 50 may be, for example, a uniform resource locator (URL). The storage unit 100 may store account information for multiple accounts corresponding to the business system 50.

The storage unit 100 further stores business process-specific information. The business process-specific information is information required to execute the business process. The business process-specific information may include various information depending on the details of the business process. For example, when a business process relates to a business trip application, the business process-specific information includes information on the travel period, the destination, the arrival time, and the transportation method.

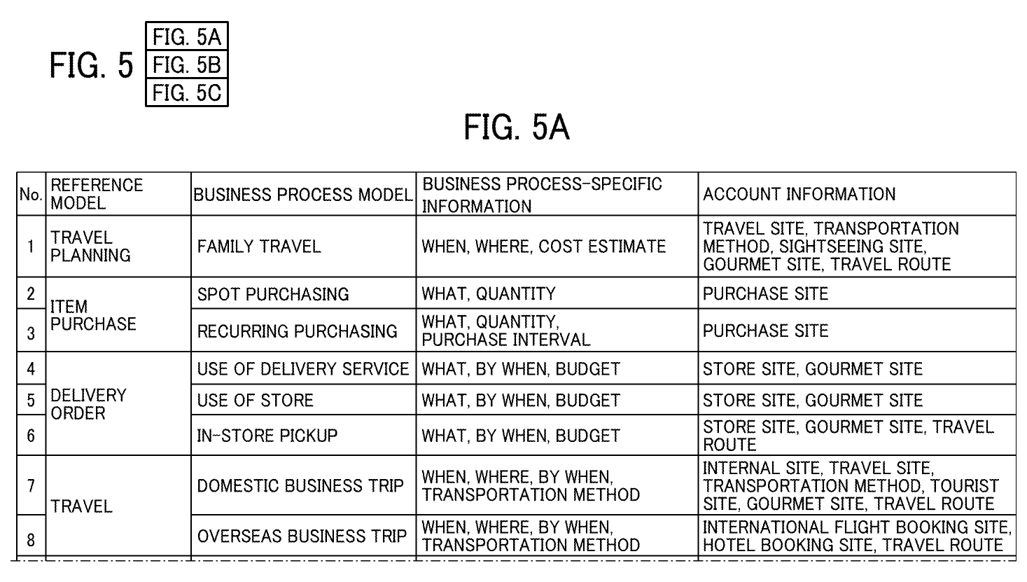

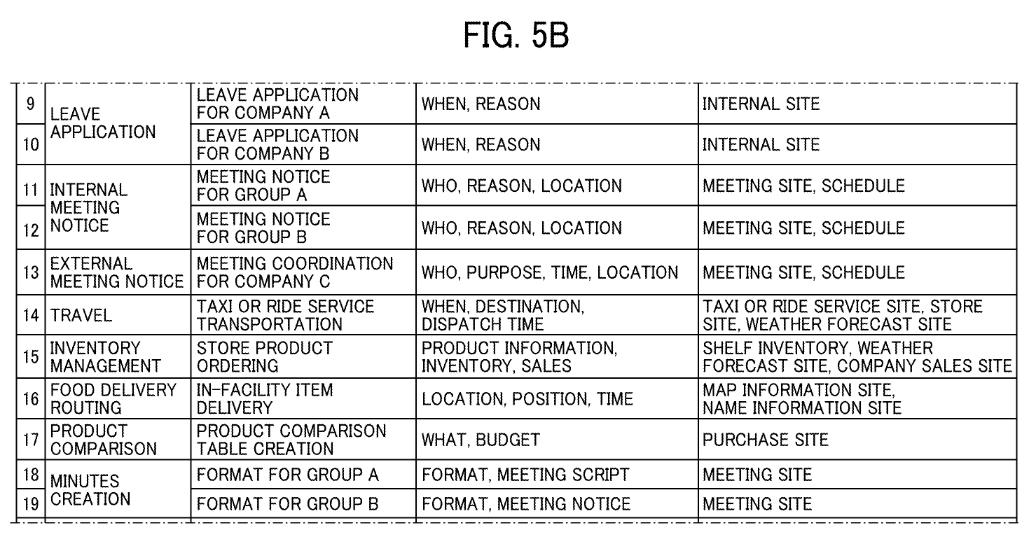

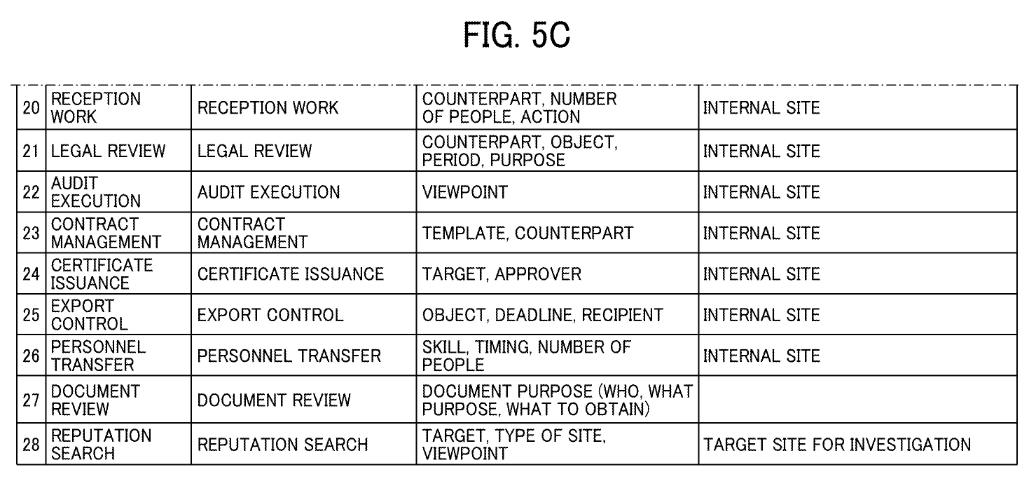

FIGS. 5A to 5C (FIG. 5) are a diagram illustrating information stored in an edge device. As illustrated in FIGS. 5A to 5C (FIG. 5), in the storage unit 100 of the edge device 10, a reference model, a business process model, business process-specific information, and account information are stored in association with each other for each business process (or each task or each set of tasks).

For example, when a reference model is a model related to planning travel (travel planning), the business process model may include a model related to family travel. In this case, the business process-specific information may also include travel period (when), travel destination (where), and cost estimate. Further, the account information in this case may include a travel site, a transportation method, a sightseeing site, a gourmet site, and a travel route.

For example, when a reference model is a model related to purchasing items (item purchase), the business process model may include a model related to spot purchasing and a model related to recurring purchasing. In this case, the business process-specific information may also include item (what) and quantity. Further, the account information in this case may include a purchase site.

The same applies to other business processes (e.g., placing takeout orders, applying for business trips and leave, coordinating meetings, arranging transportation, ordering products, routing food deliveries, comparing products, preparing meeting minutes, handling reception, reviewing legal documents, executing audits, managing contracts, issuing certificates, controlling exports, transferring personnel, reviewing documents, and conducting reputation searches). In the storage unit 100, a reference model, a business process model, business process-specific information, and account information are stored in association with each other for each business process (or each task or each set of tasks).

The description of the functional configuration of the edge device 10 is continued with reference to FIG. 4. The acquisition unit 110 acquires a reference model. The acquisition unit 110 may read a reference model pre-stored in the storage unit 100. The acquisition unit 110 may download a reference model from another information processing apparatus. The acquisition unit 110 may acquire a reference model selected by the user U from multiple reference models according to the type of business process. The acquisition unit 110 may acquire a reference model according to the business process identified by the identification unit 140.

The input unit 120 receives input of operation information. The input unit 120 may receive operation information on operations performed on the edge device 10. The input unit 120 may receive operation information transmitted from the operator terminal 15.

The training unit 130 trains a model using the operation information received by the input unit 120 to generate business process model. That is, the training unit 130 trains a model using operation information on operations performed in executing a business process based on the reference model to generate a business process model that has learned the operation information. The training unit 130 may generate business process model by training a model using operation information corresponding to multiple executions of a business process performed based on the reference model. The number of operations corresponding to the operation information used by the training unit 130 for training the model to generate a business process model may be set to any number. The number of operations corresponding to the operation information used by the training unit 130 for training the model to generate a business process model may be changed by the user U via the input unit 120.

The training unit 130 stores the generated business process model in the storage unit 100. When business process model for the same business process type is already stored in the storage unit 100, the training unit 130 updates the business process model previously stored in the storage unit 100 with the currently generated business process model.

The identification unit 140 identifies a business process based on an operation of the user U. The identification unit 140 identifies a business process based on the operation information received by the input unit 120. The identification unit 140 may identify a business process based on a time-series pattern indicated by the operation information. The identification unit 140 may identify a business process based on a business process determination model. The business process determination model is a machine learning model that learns the relationship between time-series data of operation information and a type of business process.

The request unit 150 requests the input of business process-specific information. When business process-specific information for the operation information received by the input unit 120 is incomplete or missing one or more items of information (information items) to execute the business process, the request unit 150 requests the input of information missing from the business process-specific information. The request unit 150 notifies the user U of the information missing from the business process-specific information. The request unit 150 obtains the missing information input by the user U, namely obtains the complete business process-specific information.

The execution unit 160 executes a business process based on a business process model generated by the training unit 130. The execution unit 160 reads from the storage unit 100 a business process model to be used for executing the business process. The execution unit 160 may read from the storage unit 100 a business process model selected by the user U from among a plurality of business process models corresponding to the type of business process. The execution unit 160 may read from the storage unit 100 a business process model corresponding to the business process identified by the identification unit 140.

The functional configuration of the edge device 10 illustrated in FIG. 4 is one example. The functional configuration may vary depending on the application or purpose. The classification of processing or storage units, such as the storage unit 100, the acquisition unit 110, the input unit 120, the training unit 130, the identification unit 140, the request unit 150, and the execution unit 160 illustrated in FIG. 4 is an example.

### Process

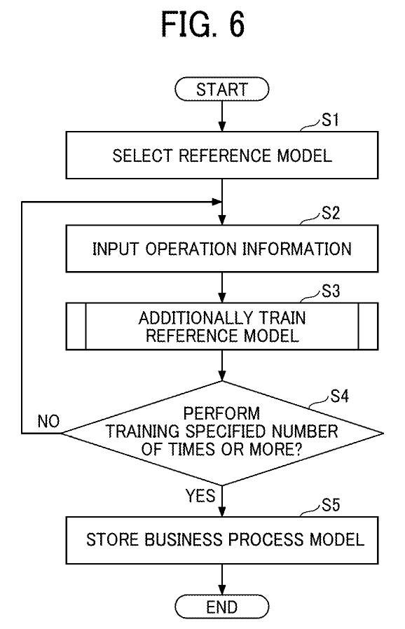

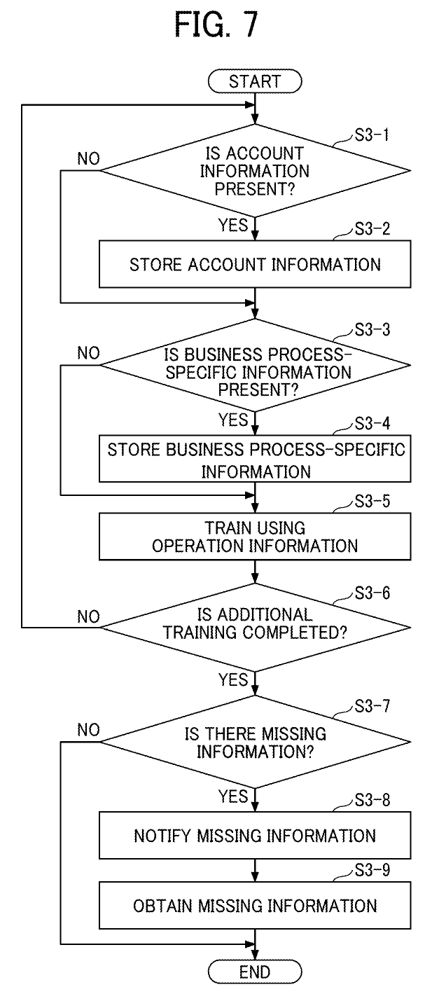

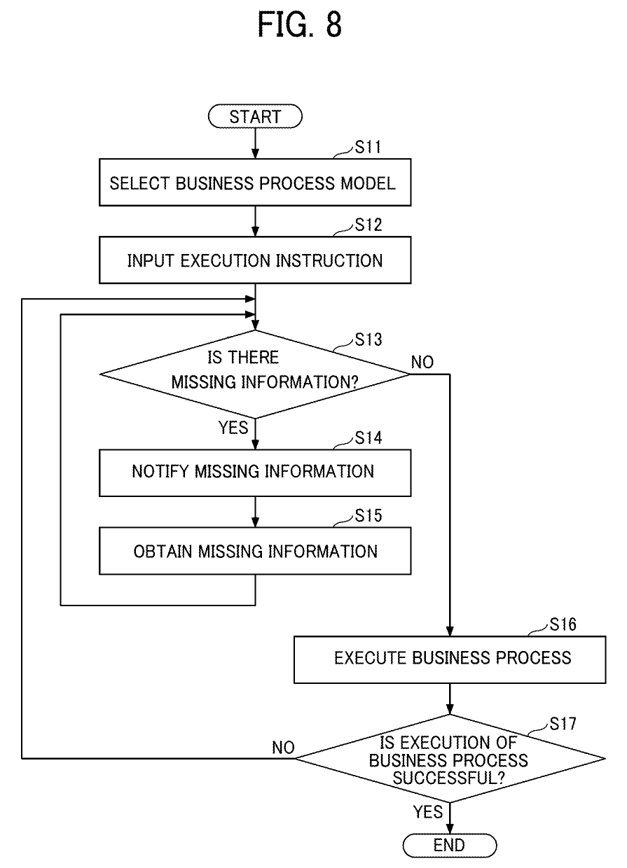

An automation method executed by the automation system 1000 is described below with reference to FIGS. 6 to 8. An automation method according to the present embodiment includes a generation process (see FIG. 6), an additional training process (see FIG. 7), and an execution process (see FIG. 8).

FIG. 6 is a flowchart of a generation process. The generation process is a process for generating a business process model by performing additional training using operation information.

In step S1, the user U selects a reference model. Accordingly, the edge device 10 receives the selection for the reference model and selects the reference model. The user U may indirectly select the reference model by selecting a type of business process. The user U may select the reference model by performing an operation related to a business process. For example, when a business process is applying for a business trip (business trip application), an operation related to the business process may include inputting information to a web page that provides route information or to a screen for submitting a business trip application to the workplace or transmitting the information input to the screen. In this case, the identification unit 140 of the edge device 10 identifies the business process based on the operation performed by the user U.

The acquisition unit 110 of the edge device 10 acquires the reference model selected by the user U. The acquisition unit 110 may read the reference model selected by the user U from the storage unit 100. The acquisition unit 110 may download the reference model selected by the user U from another information processing apparatus.

In step S2, the user U performs an operation to execute the business process based on the reference model. The input unit 120 of the edge device 10 receives operation information on operations performed in executing the business process based on the reference model. The input unit 120 transmits the received operation information to the training unit 130.

In step S3, the training unit 130 of the edge device 10 receives the operation information from the input unit 120. The training unit 130 additionally trains the reference model using the operation information received from the input unit 120. The training unit 130 stores the additionally trained reference model in the storage unit 100.

In step S4, the training unit 130 of the edge device 10 determines whether the number of times the reference model has been additionally trained is equal to or greater than a specified number. In the following description, the number of times the reference model has been additionally trained may be referred to as the number of additional trainings. When the training unit 130 determines that the number of additional trainings is equal to or greater than a specified number (YES), the process proceeds to step S5. On the other hand, when the training unit 130 determines that the number of additional trainings is less than the specified number (NO), the process returns to step S2.

When the process returns to step S2, the input unit 120 of the edge device 10 receives additional operation information. The training unit 130 of the edge device 10 executes the processing from step S2 to step S4 again on the additional operation information. In step S4, the edge device 10 repeatedly executes the processing from step S2 to step S4 until the number of additional trainings reaches or exceeds the specified number.

In step S5, the training unit 130 of the edge device 10 stores the additionally trained reference model in the storage unit 100 as the business process model. When step S3 has been executed multiple times, the training unit 130 stores the additionally trained reference model obtained in the last execution of step S3 in the storage unit 100 as the business process model.

FIG. 7 is a flowchart of an additional training process. The additional training process corresponds to step S3 of the generation process illustrated in FIG. 6.

In step S3-1, the training unit 130 of the edge device 10 determines whether the operation information received by the input unit 120 includes account information. When the training unit 130 determines that the operation information includes account information (YES), the process proceeds to step S3-2. On the other hand, when the training unit 130 determines that the operation information does not include account information (NO), the process proceeds to step S3-3.

In step S3-2, the training unit 130 of the edge device 10 stores the account information included in the operation information in the storage unit 100. When the account information related to the same business system 50 is already stored in the storage unit 100, the training unit 130 may update the account information already stored in the storage unit 100 with the account information included in the operation information.

In step S3-3, the training unit 130 of the edge device 10 determines whether the operation information received by the input unit 120 includes business process-specific information. When the training unit 130 determines that the operation information includes business process-specific information (YES), the process proceeds to step S3-4. On the other hand, when the training unit 130 determines that the operation information does not include business process-specific information (NO), the process proceeds to step S3-5.

In step S3-4, the training unit 130 of the edge device 10 stores the business process-specific information included in the operation information in the storage unit 100. When business process-specific information of the same type as that included in the operation information is already stored in the storage unit 100, the training unit 130 may update the business process-specific information already stored in the storage unit 100 with the business process-specific information included in the operation information.

In step S3-5, the training unit 130 of the edge device 10 updates the reference model by performing training (additional training) using the operation information. The training unit 130 stores the updated reference model in the storage unit 100.

In step S3-6, the training unit 130 of the edge device 10 determines whether the additional training has been completed. For example, the training unit 130 may determine that the additional training is completed when all of the operation information received by the input unit 120 has been learned by the reference model. When the training unit 130 determines that the additional training is completed (YES), the process proceeds to step S3-7. On the other hand, when the training unit 130 determines that the additional training has not been completed (NO), the process returns to step S3-1.

When the process returns to step S3-1, the training unit 130 of the edge device 10 receives additional operation information. The training unit 130 executes the processing from step S3-1 to step S3-6 again on the additional operation information. The edge device 10 repeatedly executes the processing from step S3-1 to step S3-6 until the additional training is determined to be completed in step S3-6.

In step S3-7, the request unit 150 of the edge device 10 determines whether there is any information missing from the business process-specific information, namely, whether there are one or more missing items of information for the business process-specific information. In the following, the information missing from the business process-specific information may be referred to as missing information. For example, in the case of business trip application, when the business process-specific information does not include information on the location (where) and time (when), this information is the missing information. For example, when the business process-specific information stored in the storage unit 100 does not include one or more information items required to execute the business process model, the request unit 150 determines that there is missing information. When the request unit 150 determines that there is missing information (YES), the process proceeds to step S3-8. On the other hand, when the request unit 150 determines that there is no missing information (that is, the business process-specific information is complete) (NO), the additional training process ends.

In step S3-8, the request unit 150 of the edge device 10 notifies the user U of the missing information determined in step S3-7. For example, the request unit 150 of the edge device 10 may display a screen requesting the input of the missing information.

In step S3-9, the user U inputs the missing information. Accordingly, the request unit 150 of the edge device 10 obtains the missing information input by the user U. The request unit 150 stores the obtained missing information in the storage unit 100, and the business process-specific information in the storage unit 100 becomes complete information to execute the business process accordingly.

FIG. 8 is a flowchart of an execution process. The execution process is a process for executing a business process based on a business process model generated by the generation process.

In step S11, the user U selects a business process model. Accordingly, the edge device 10 receives the selection for the business process model and selects the business process model. The user U may indirectly select the business process model by selecting a type of business process. The user U may select the business process model by performing an operation related to a business process. In this case, the identification unit 140 of the edge device 10 identifies the business process based on the operation performed by the user U. The acquisition unit 110 of the edge device 10 reads the business process model selected by the user U from the storage unit 100.

In step S12, the user U inputs an instruction for executing the business process. Accordingly, the edge device 10 receives the instruction. The instruction for executing the business process is information instructing the details of the business process for which the execution is desired by the user U. The instruction for executing the business process may include a part or all of the business process-specific information. The input unit 120 of the edge device 10 receives operation information on operations performed in inputting the instruction for executing the business process. The input unit 120 transmits the received operation information to the request unit 150.

In step S13, the request unit 150 of the edge device 10 receives the operation information from the input unit 120. The request unit 150 determines whether there is any missing information in the business process-specific information included in the operation information. When the request unit 150 determines that there is missing information (YES), the process proceeds to step S14. On the other hand, when the request unit 150 determines that there is no missing information (in other words, the business process-specific information is complete) (NO), the request unit 150 transmits the operation information to the execution unit 160, and the process proceeds to step S16.

In step S14, the request unit 150 of the edge device 10 notifies the user U of the missing information determined in step S13. For example, the request unit 150 of the edge device 10 may display a screen requesting the input of the missing information.

In step S15, the user U inputs the missing information. Accordingly, the request unit 150 of the edge device 10 obtains the missing information input by the user U. The request unit 150 stores the obtained missing information in the storage unit 100, and the business process-specific information in the storage unit 100 becomes complete information to execute the business process accordingly. After the request unit 150 obtains the business process-specific information, the process returns to step S13.

When the process returns to step S13, the request unit 150 of the edge device 10 determines again whether there is missing information. In other words, the request unit 150 determines whether the missing information is successfully obtained in step S15. The request unit 150 repeatedly executes the processing of steps S14 and S15 until the request unit 150 determines that there is no missing information in the business process-specific information in step S13.

In step S16, the execution unit 160 of the edge device 10 executes the business process based on the business process model selected in step S11. When executing the business process, the execution unit 160 reads the account information and the business process-specific information that are required for the execution from the storage unit 100. The execution unit 160 connects to the business system 50 based on the account information. Further, the execution unit 160 causes the business system 50 to execute processing related to the business process based on the business process-specific information. When the execution unit 160 completes the execution of the business process, the execution unit 160 present the processing result to the user U. For example, the execution unit 160 may display a screen including the processing result.

In step S17, the execution unit 160 of the edge device 10 determines whether the execution of the business process is successful. For example, the execution unit 160 may determine that the execution of the business is successful when an approval process for the business process has been executed. For example, the execution unit 160 may determine that the execution of the business is successful when all processing is completed without any errors occurring in the business system 50. For example, when one or more errors occur in the business system 50, the execution unit 160 may determine that the execution of the business process is unsuccessful.

When the execution unit 160 determines that the execution of the business process is successful (YES), the process ends. On the other hand, when the execution unit 160 determines that the execution of the business process is unsuccessful (NO), the process returns to step S13.

The edge device 10 according to the first embodiment generates a business process model that has learned operation information on operations performed in executing one or more tasks including multiple operations based on the reference model for executing the one or more tasks, and executes the business process based on the business process model.

According to one aspect of the present embodiment, a business process model is generated by additionally learning a reference model that has been pre-trained on basic operations related to one or more tasks, thereby allowing the one or more tasks to be automated with fewer operations. According to the present embodiment, one or more tasks can be performed efficiently.

### Second Embodiment

An automation system according to a second embodiment is another example of an automation system that automates one or more tasks. The automation system according to the present embodiment includes a management server that manages reference models. The management server is configured to pre-train a reference model. Further, the management server is configured to deliver the reference model to an edge device.

An automation system 1000A according to the second embodiment is described below, focusing on the differences from the first embodiment. The automation system 1000A according to the second embodiment may be configured in the same manner as in the first embodiment unless otherwise noted.

### Overall Configuration

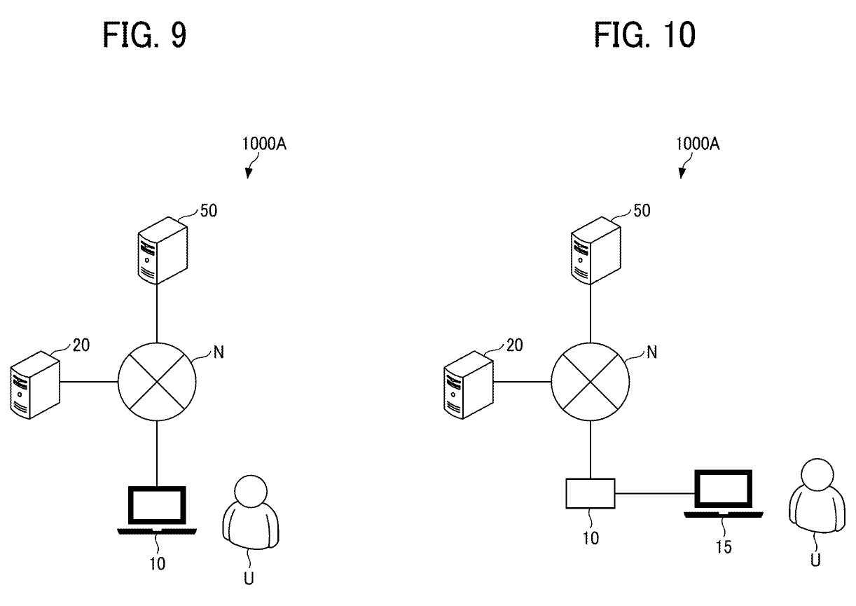

FIG. 9 is a diagram illustrating an overall configuration of an automation system according to the second embodiment. As illustrated in FIG. 9, the automation system 1000A includes the edge device 10, a management server 20, and the business system 50. The management server 20 is connected to the edge device 10 and the business system 50 via the communication network N for data communication. The automation system 1000A according to the second embodiment is different from that of the first embodiment in that the automation system 1000A includes the management server 20.

The management server 20 is an example of an information processing apparatus that manages the automation system 1000. For example, the management server 20 may be implemented by a computer such as a personal computer, a workstation, or a server. For example, the management server 20 may be implemented by a computer having the hardware configuration illustrated in FIG. 3.

The management server 20 manages the operation information provided by the edge device 10. The management server 20 pre-trains the reference model based on the operation information provided by the edge device 10. The management server 20 manages reward information related to the provision of operation information. The reward information related to the provision of operation information is information about the reward provided by or the compensation paid from the operating entity of the automation system 1000A to the operating entity of the edge device 10. The operating entity may include, for example, a user, an owner, or an administrator. The operating entity may be a natural person or a legal entity. The reward may be provided in currency or in a payment instrument convertible into currency, such as points, coupons, electronic money, or virtual currency.

The management server 20 delivers a reference model to the edge device 10. The management server 20 manages the usage status of the reference model delivered to the edge device 10. The management server 20 manages reward information related to the use of the reference model. The reward information related to the use of the reference model is information about the reward provided by or the compensation paid from the operating entity of the edge device 10 to the operating entity of the automation system 1000.

The management server 20 may include multiple information processing apparatuses having different functions. For example, the management server 20 may include a first management server that pre-trains a reference model and a second management server that distributes or delivers the reference model.

FIG. 10 is another diagram illustrating an overall configuration of an automation system according to the second embodiment. As illustrated in FIG. 10, the automation system 1000A may further include the edge device 10, the operator terminal 15, the management server 20, and the business system 50. In the automation system 1000A according to the present embodiment, the edge device 10 that executes a business process and the operator terminal 15 operated by the user U may be separated, similar to the automation system 1000A illustrated in FIG. 2.

The overall configuration of the automation system 1000A illustrated in FIG. 9 or FIG. 10 is one example, and the system configuration may vary depending on the application or purpose. For example, the automation system 1000A may include two or more management servers 20. For example, the management server 20 may be implemented by multiple computers or may be implemented as a cloud computing service.

### Functional Configuration

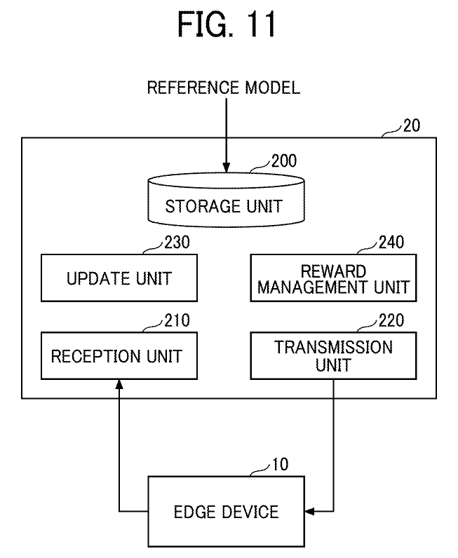

A functional configuration of the automation system 1000A is described below with reference to FIG. 11. FIG. 11 is a block diagram illustrating a functional configuration of a management server.

As illustrated in FIG. 11, the management server 20 includes a storage unit 200, a reception unit 210, a transmission unit 220, an update unit 230, and a reward management unit 240. The management server 20 executes one or more programs that are pre-installed to function as the storage unit 200, the reception unit 210, the transmission unit 220, the update unit 230, and the reward management unit 240.

For example, the storage unit 200 is implemented by the HDD 504 illustrated in FIG. 3. For example, the reception unit 210, the transmission unit 220, the update unit 230, and the reward management unit 240 are implemented by processing executed by the CPU 501 according to a program loaded to the RAM 503 from the HDD 504 illustrated in FIG. 3.

The storage unit 200 stores a reference model. The reference model may be generated outside the management server 20 and input to the management server 20. The reference model may be generated within the management server 20 and stored in the storage unit 200. The storage unit 200 may store multiple reference models according to the type of business process.

The storage unit 200 stores management information. The management information includes model usage management information and data provision management information. The model usage management information is information for managing the usage status of the reference model by the edge device 10. The data provision management information is information for managing the provision status of the operation information from the edge device 10. The data provision management information includes the operation information provided by the edge device 10.

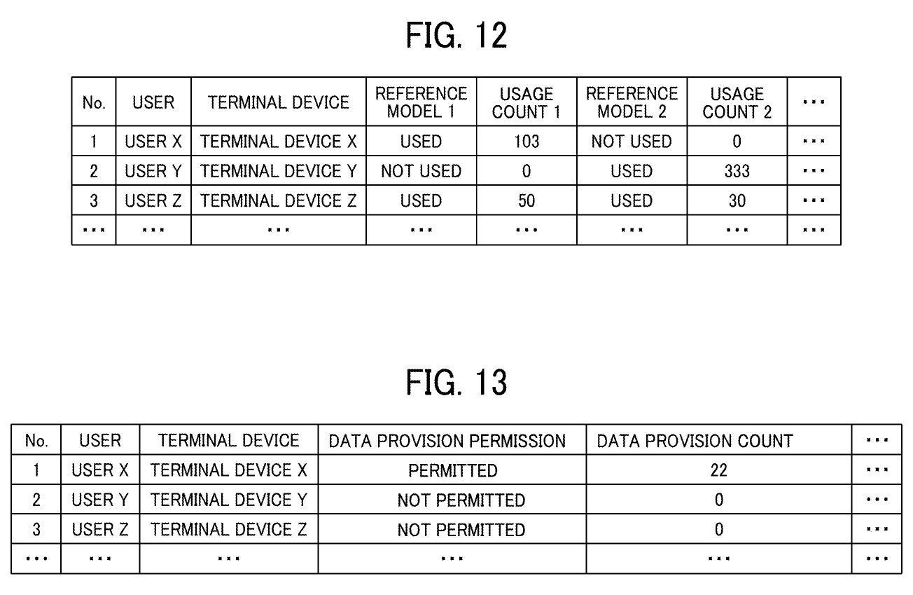

FIG. 12 is a diagram illustrating model usage management information. In this embodiment, the model usage management information is stored in a database table. As illustrated in FIG. 12, the model usage management information includes data items such as a number (No.), a user, a terminal device, a reference model n, and a usage count of the reference model n (n=1, 2, ...). The data item “number” represents identification information for each record. The data item “user” indicates the user U of the edge device 10. The data item “terminal device” indicates the edge device 10 used by the user U. The data item “reference model n” indicates whether the “n”th reference model is used. The data item “usage count of the reference model n” indicates the number of times the “n”th reference model has been used.

FIG. 13 is a diagram illustrating data provision management information. In this embodiment, the data provision management information is stored in a database table. As illustrated in FIG. 13, the data provision management information includes data items such as a number (No.), a user, a terminal device, data provision permission, and a data provision count. The data items “number,” “user,” and “terminal device” have the same meaning as those in the model usage management information. The data item “data provision permission” indicates whether operation information is permitted to be provided by the edge device 10, namely, whether operation information can be provided by the edge device 10. The data item “data provision count” indicates the number of times operation information has been provided from the edge device 10.

Further, the information indicating whether operation information can be provided, such as the “data provision permission,” may be set for the edge device 10 when management information related to the edge device 10 is registered. For example, when the management information related to the edge device 10 is stored in the storage unit 200, the management server 20 requests a response indicating whether to permit data provision from the edge device 10. For example, the edge device 10 displays a screen to receive input of a response from the user U. The response indicates whether to permit data provision. The edge device 10 transmits information indicating whether operation information can be provided to the management server 20, based on the response input by the user U on the screen.

The description of the functional configuration of the management server 20 is continued with reference to FIG. 11. The reception unit 210 receives an acquisition request for a reference model from the edge device 10. The acquisition request for a reference model includes information indicating a reference model to be obtained. The reference model to be obtained is selected by the user U.

The reception unit 210 receives operation information from the edge device 10. The reception unit 210 receives operation information from the edge device 10 that has permitted data provision. The reception unit 210 stores the operation information received from the edge device 10 in the data provision management information stored in the storage unit 200.

The edge device 10 may notify the user U that the operation information is being provided. For example, the edge device 10 or the operator terminal 15 may output information indicating that the operation information is being provided while providing the operation information. The edge device 10 or the operator terminal 15 may output the information indicating the operation information is being provided by, for example, displaying a message or an icon, changing the color of the display, outputting sound, or operating a wearable device.

The reception unit 210 may receive the operation information where predetermined information has been concealed, from the edge device 10. The predetermined information included in the operation information may be concealed by the edge device 10 or may be concealed by the operator terminal 15.

The predetermined information may include personal information, confidential information, or authentication information. The personal information may include a name, address, telephone number, date of birth, email address, identification number, bank account details, or credit card information. The confidential information may include trade secrets, customer information, state secrets, or unpublished information. The authentication information may include an account name, password, secret questions, biometric data, a shared key, or a private key.

The transmission unit 220 transmits the reference model to the edge device 10. The transmission unit 220 transmits the reference model to the edge device 10 in response to the acquisition request for a reference model. The acquisition request for a reference model includes information indicating a reference model to be obtained. The transmission unit 220 reads the reference model indicated by the acquisition request for a reference model from the storage unit 200 and transmits the reference model to the edge device 10.

The update unit 230 updates a reference model. The update unit 230 updates the reference model based on operation information stored in the storage unit 200. The update unit 230 updates the reference model based on operation information provided by the edge device 10. The update unit 230 updates the reference model by training the reference model using the operation information.

The reward management unit 240 generates reward information. The reward management unit 240 generates the reward information based on management information stored in the storage unit 200. The reward management unit 240 generates the reward information related to the use of the reference model based on the model usage management information. For example, the reward management unit 240 may calculate an amount of reward to be claimed to the operating entity of the edge device 10 based on the number of times the edge device 10 has used the reference model. For example, the reward management unit 240 may calculate an amount of reward to be claimed to the operating entity of the edge device 10 for each reference model used by the edge device 10.

The reward management unit 240 generates reward information related to the provision of operation information based on the data provision management information. For example, the reward management unit 240 may calculate an amount of reward to be provided to the operating entity of the edge device 10 based on the number of times operation information has been provided from the edge device 10. For example, the reward management unit 240 may calculate an amount of reward to be provided to the operating entity of the edge device 10 based on the size of the operation information provided by the edge device 10.

The functional configuration of the management server 20 illustrated in FIG. 11 is one example. The functional configuration may vary depending on the application or purpose. The classification of processing or storage units, such as the storage unit 200, the reception unit 210, the transmission unit 220, the update unit 230, and the reward management unit 240 illustrated in FIG. 11 is an example.

### Process

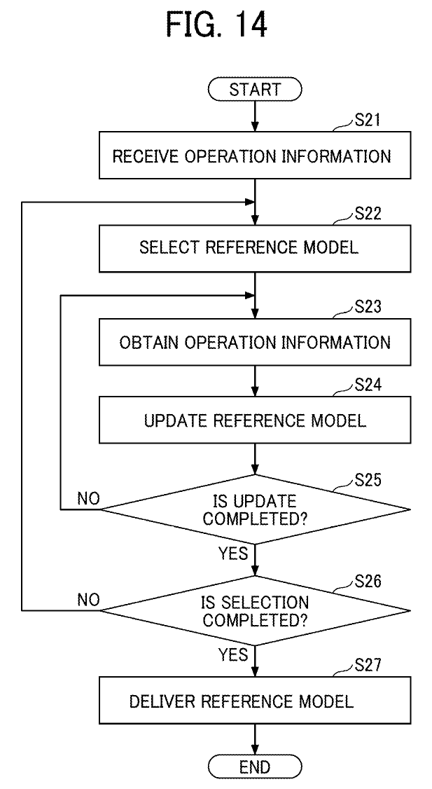

A management method performed by the automation system 1000A is described with reference to FIG. 14. FIG. 14 is a flowchart of a management method.

In step S21, the user U operates the edge device 10 that permits data provision to execute a business process. Accordingly, the edge device 10 receives input of operation information. The user U may perform a business process using the reference model or without using the reference model. The edge device 10 transmits the operation information on operations performed in executing the business process to the management server 20.

The reception unit 210 of the management server 20 receives the operation information from the edge device 10. The reception unit 210 stores the operation information received from the edge device 10 in the data provision management information stored in the storage unit 200.

In step S22, the update unit 230 of the management server 20 selects a reference model. The update unit 230 may select the reference model based on an operation performed by the administrator. The update unit 230 may select the reference model based on the operation information stored in the storage unit 200. For example, the update unit 230 may identify a business process based on the operation information and select the reference model according to the identified business process.

The update unit 230 obtains the selected reference model. The update unit 230 may read the selected reference model from the reference models stored in the storage unit 200.

In step S23, the update unit 230 of the management server 20 obtains the operation information provided by the edge device 10. The update unit 230 reads from the storage unit 200 the operation information on operations performed in executing the business process corresponding to the reference model selected in step S22.

In step S24, the update unit 230 of the management server 20 updates the reference model selected in step S22 based on the operation information obtained in step S23. In other words, the update unit 230 updates the reference model by training the reference model using the operation information on operations performed in executing the business process.

In step S25, the update unit 230 of the management server 20 determines whether the update of the reference model is completed. For example, the update unit 230 may determine that the update of the reference model is completed when the operation information corresponding to a predetermined number of operations has been learned by the reference model. For example, the update unit 230 may determine that the update of the reference model is completed when the reference model has learned all of the operation information related to the business process corresponding to the reference model selected in step S22 from the operation information stored in the storage unit 200.

When the update unit 230 determines that the update of the reference model is completed (YES), the process proceeds to step S26. On the other hand, when the update unit 230 determines that the update of the reference model is not completed (NO), the process returns to step S23.

When the process returns to step S23, the update unit 230 reads additional operation information from the storage unit 200. The update unit 230 executes the processing from step S23 to step S25 again on the additional operation information. The management server 20 repeatedly executes the processing from step S23 to step S25 until the update of the reference model is determined to be completed in step S25.

In step S26, the update unit 230 of the management server 20 determines whether the selection of the reference model is completed. For example, the update unit 230 may determine that the selection of the reference model is completed when no additional reference model is selected by the administrator. For example, the update unit 230 may determine that the selection of the reference model is completed when there is no operation information related to other business processes stored in the storage unit 200.

When the update unit 230 determines that the selection of the reference model is completed (YES), the process proceeds to step S27. On the other hand, when the update unit 230 determines that the selection of the reference model is not completed (NO), the process returns to step S22.

When the process returns to step S22, the update unit selects an additional reference model. The update unit 230 executes the processing from step S22 to step S26 again on the additional reference model. The management server 20 repeatedly executes the processing from step S22 to step S26 until the selection of the reference model is determined to be completed in step S26.

In step S27, the user U selects a reference model. The acquisition unit 110 of the edge device 10 transmits an acquisition request for the reference model to the management server 20. The acquisition request for a reference model includes information indicating the reference model specified by the user U.

The reception unit 210 of the management server 20 receives the acquisition request for a reference model from the edge device 10. The reception unit 210 obtains the information indicating the reference model from the acquisition request and transmits the information to the transmission unit 220. The transmission unit 220 reads the reference model from the storage unit 200 based on the information received from the reception unit 210. The transmission unit 220 transmits the reference model read from the storage unit 200 to the edge device 10.

The acquisition unit 110 of the edge device 10 receives the reference model from the management server 20. The acquisition unit 110 stores the reference model received from the management server 20 in the storage unit 100.

The management server 20 according to the second embodiment is an information processing apparatus that can communicate with the edge device 10 via the communication network N, stores a reference model for executing one or more tasks including multiple operations, receives an acquisition request for a reference model from the edge device 10, and transmits the reference model to the edge device 10.

In one aspect, the management server 20 according to the present embodiment can deliver a reference model that has been pre-trained on basic operations related to one or more tasks to the edge device 10 via the communication network N. The edge device 10 can efficiently perform the one or more tasks by additionally training the reference model. According to the present embodiment, one or more tasks can be performed efficiently.

The management server 20 according to the present embodiment is an information processing apparatus that can communicate with the edge device 10 via the communication network N, stores a reference model for executing one or more tasks including multiple operations, receives operation information indicating operations performed in executing the one or more tasks from the edge device 10, and updates the reference model by training using the operation information.

In one aspect, the management server 20 according to the present embodiment can generate a highly accurate reference model by updating the reference model based on operation information received from the edge device 10. The edge device 10 can efficiently execute the one or more tasks by additionally training the reference model delivered from the management server 20. According to the present embodiment, the one or more tasks can be performed efficiently.

In the above-described embodiments of the present disclosure, the edge device 10 is an example of an information processing apparatus, and the management server 20 is an example of a second information processing apparatus. Additionally, the edge device 10 is another example of a second information processing apparatus, and the management server 20 is another example of an information processing apparatus. The operator terminal 15 is an example of a third information processing apparatus. The reference model is an example of first electronic data. The business process model is an example of a second electronic data.

There is room for enhancing the efficiency of performing tasks in the related art. In the related art, automating tasks requires a user to perform numerous operations in advance, which places a significant burden on the user.

According to the present embodiment, one or more tasks can be performed efficiently.

Each of the above-described functions may be implemented by one or more pieces of processing circuitry. The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or digital versatile disc (DVD), and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus, comprising circuitry configured to:
obtain first electronic data for executing a task including a plurality of operations;
perform training using operation information to generate second electronic data, the operation information indicating one or more user operations performed in executing the task based on the first electronic data; and
execute the task based on the second electronic data.

2. The information processing apparatus according to claim 1, wherein
the operation information indicating the one or more user operations correspond to a plurality of executions of the task.

3. The information processing apparatus according to claim 1, wherein
the circuitry is further configured to identify the task based on an additional user operation; and
perform the training using the operation information obtained in executing the identified task.

4. The information processing apparatus according to claim 1, wherein
the circuitry is further configured to identify the task based on an additional user operation; and
execute the task based on the second electronic data related to the identified task.

5. The information processing apparatus according to claim 1, wherein
the circuitry is further configured to request input of missing information when information for executing the task is incomplete.

6. The information processing apparatus according to claim 1, wherein
the circuitry is further configured to receive the first electronic data from another information processing apparatus communicably connected to the information processing apparatus via a network.

7. The information processing apparatus according to claim 1, wherein
the circuitry is further configured to obtain the operation information from another information processing apparatus communicably connected to the information processing apparatus.

8. An electronic data provision apparatus communicably connected to an information processing apparatus, the electronic data provision apparatus comprising:
a memory that stores first electronic data for executing a task including a plurality of operations; and
circuitry configured to:
receive a request from the information processing apparatus for acquisition of the first electronic data; and
transmit the first electronic data to the information processing apparatus.

9. The electronic data provision apparatus according to claim 8, wherein
the circuitry is further configured to store management information in the memory, the management information including at least one of first information indicating the first electronic data transmitted to the information processing apparatus or second information indicating the number of times the information processing apparatus used the first electronic data.

10. The electronic data provision apparatus according to claim 9, wherein
the circuitry is further configured to generate information on a reward related to use of the first electronic data based on the management information.

11. An electronic data provision apparatus communicably connected to an information processing apparatus, the electronic data provision apparatus comprising:
a memory that stores first electronic data for executing a task including a plurality of operations; and
circuitry configured to:
receive, from the information processing apparatus, operation information indicating a user operation performed in executing the task; and
perform training using the operation information to update the first electronic data.

12. The electronic data provision apparatus according to claim 11, wherein circuitry configured to:
receive a request from the information processing apparatus for acquisition of the first electronic data; and
transmit the first electronic data to the information processing apparatus.

13. The electronic data provision apparatus according to claim 11, wherein
the circuitry is further configured to store management information in the memory, the management information including first information indicating the information processing apparatus and second information indicating whether the operation information is permitted to be provided from the information processing apparatus to the electronic data provision apparatus.

14. The electronic data provision apparatus according to claim 13, wherein
the information processing apparatus is set to permit provision of the operation information, and
the management information includes the operation information received from the information processing apparatus.

15. The electronic data provision apparatus according to claim 11, wherein
the operation information includes predetermined information that has been concealed.

16. The electronic data provision apparatus according to claim 11, wherein
the circuitry is further configured to generate information on a reward for provision of the operation information based on the operation information received from the information processing apparatus.

17. A non-transitory recording medium storing a plurality of instructions which, when executed by one or more processors, causes the one or more processors to perform a method, the method comprising:
obtaining first electronic data for executing a task including a plurality of operations; and
performing training using operation information indicating a user operation performed in executing the task based on the first electronic data to generate second electronic data.
